(19) United States
(12) Patent Application Publication
(10) Pub. No.: US 2004/0240056 A1
(43) Pub. Date: Dec. 2, 2004

(54) Display apparatus and method

(76) Inventors: Isao Tomisawa, Saitama (JP); Daisuke Suma, Tokyo (JP)

Correspondence Address: YOUNG & THOMPSON, 745 SOUTH 23RD STREET, 2ND FLOOR, ARLINGTON, VA, 22202, US

(21) Appl. No.: 10/858,368

(22) Filed: Jun. 2, 2004

(30) Foreign Application Priority Data
Jun. 2, 2003 (JP) 2003-156497

(51) Int. Cl. G02B 27/22; G02B 27/26

(52) U.S. Cl. 359/462

(57) ABSTRACT

The display apparatus (1) is provided with: a plurality of displaying devices (11, 12) disposed in tandem on a view line of an observer, for displaying a plurality of images relating to a plurality of display objects in an overlapped manner on the view line; an output level control device (21) for designating an output brightness level of each of the plurality of images, depending on both (i) a depth position of each of the plurality of display objects, the depth position being defined between or among the plurality of displaying devices and (ii) contents of each of the plurality of display objects; and an output level distribution device (22) for distributing an input video signal for displaying the plurality of display objects, as an output video signal having the designated output brightness level, to each of the plurality of displaying devices.

### BACKGROUND OF THE INVENTION

1. Field of the Invention

The present invention relates to a display apparatus and method in a stereoscopic display system such as a brightness modulation system, in which a plurality of displaying devices may be disposed in tandem on a view line of an observer so that an object is displayed stereoscopically by displaying images on each displaying device in an overlapped manner and changing each brightness of the images, among the plurality of displaying devices, depending on a depth position of the object.

2. Description of the Related Art

Heretofore, various types of apparatuses capable of displaying a stereoscopic image are proposed, and are in practical use. For example, an LCS (Liquid. Crystal Shutter) glasses system and the like are well known as the apparatus for displaying stereoscopically a motion image. According to the LCS glasses system, a three-dimensional object is shot with a camera from different directions, video data including parallax information is composed into a video signal, and the video signal is inputted into a two-dimensional display apparatus where the image is displayed. An observer wearing the LCS glasses can view a stereoscopic image based on a parallax between right and left eyes, while LCS's for right and left eyes are switched in synchronization with the image to be displayed.

Recently, a three-dimensional apparatus is proposed, in which two pieces of two-dimensional displaying devices are disposed in tandem on a view line of the observer, so that a stereoscopic image is obtained even though it in discrete in a depth direction, by viewing images displayed on each two-dimensional displaying device in an overlapped manner. To improve such a discrete manner, an improved three-dimensional display apparatus or stereoscopic display apparatus is proposed, in which brightness of each object to be displayed on each two-dimensional displaying device is varied depending on a depth position of each object, so that a stereoscopic image is displayed as if the object exists at an intermediate position between such discrete positions, resulting in more natural three-dimensional effect. For example, a brightness modulation type of stereoscopic display system is proposed (for example, see Japanese Patent Application Laid-Open No. 2000-115812), in which a semi-transparent object is displayed or any other display through which another object backward is transparently viewed is allowed, by displaying object images originated from a plurality of displaying devices in an overlapped manner using a plurality of half mirrors.

### SUMMARY OF THE INVENTION

In such a brightness modulation type of stereoscopic display system, however, there is a technical problem that the observer can not get a satisfactory three-dimensional effect for some contents of the image. For example, in the case that an image is displayed representing (i) a relatively small man, that is, a display object having a narrow range of depth direction along the observer's view line and (ii) a relatively big mountain, that is, a display object having a wide range of the depth direction, a three-dimensional effect applied to the man part of the image becomes weak in comparison with a three-dimensional effect applied to the mountain part of the image. Thereby, a satisfactory three-dimensional effect can not be obtained for the man part of the image. In this case, there is a technical problem that the man part of the image for example is displayed only to an extent substantially as much as that of a two-dimensional image, in comparison with the mountain part of the image. Otherwise, there is a technical problem that a three-dimensional effect can not be emphasized for a desired display object among a plurality of display objects depicted in an image.

The present invention has been accomplished in view of the above problems for example. It is therefore an object of the invention to provide a display apparatus for and method of displaying an image having an appropriate three-dimensional effect as for any contents in the image to be displayed.

The above object of the present invention is achieved by a first display apparatus comprising: a plurality of displaying devices disposed in tandem on a view line of an observer, for displaying a plurality of images relating to a plurality of display objects in an overlapped manner on the view line; an output level control device for designating an output brightness level of each of the plurality of images, depending on both (i) a depth position of each of the plurality of display objects, the depth position being defined between or among the plurality of displaying devices and (ii) contents of each of the plurality of display objects; and an output level distribution device for distributing an input video signal for displaying the plurality of display objects, as an output video signal having the designated output brightness level, to each of the plurality of displaying devices.

According to the first display apparatus, during its operation, the plurality of displaying devices disposed in tandem on the observer's view line display a plurality of images for a stereoscopic display in an overlapped manner as seen from the observer, resulting in the stereoscopic display or three-dimensional display. That is, the observer can view a stereoscopic image. The expression “display . . . in an overlapped manner as seen from the observer” herein is intended to include, in addition to a full overlapping of the literal meaning, an extent of overlapping in part to which the observer can view a stereoscopic image. Furthermore, the expression “the plurality of images relating to the display object” according to the present invention is intended to include a plurality of images relating to different display objects, such as a road image with an arrow image for indicating a travel direction overlapped or superimposed on the road image on a display apparatus in a car navigation system, in addition to the plurality of images relating to the same display object.

Then, brightness is defined with regard to the same part of each images to be displayed on these two displaying devices, so that a continuous stereoscopic display is obtained, as if images exist at a depth position between these two displaying devices. Alternatively, a discrete stereoscopic display is obtained in which the image part is displayed either one of these two displaying devices. Furthermore, it is also possible to achieve a continuous or discrete stereoscopic display, as if images exist at a position among three or more displaying devices.

Particularly in the first display apparatus, when the brightness is defined, the output level control device designates the output brightness level with regard to the plurality of images, depending on both (i) a depth position of a display object and (ii) contents of a display object (e.g. kind of display object, extent of three-dimensional effect, etc.). For example, in order to emphasize the three-dimensional effect of a display object, the output brightness level can be designated so that the three-dimensional effect of the display object is emphasized. Alternatively, in order not to emphasize the three-dimensional effect of a display object, the output brightness level can be designated so that the three-dimensional effect of the display object is not emphasized. In any case, a predetermined or desired output brightness level is designated, depending on both the depth position of the display object and the contents of the display object.

Then, the output level distribution device converts an input video signal indicating an original image (or original images) for displaying the plurality of display objects, into output video signals indicating the plurality of images each having the output brightness level designated by the output level control device. Then, the output video signals are distributed into the plurality of displaying devices respectively.

Then, the plurality of displaying devices into which output video signals are distributed display the plurality of images for a stereoscopic display in an overlapped manner on the observer's view line, so that the observer can view a stereoscopic image.

In a conventional brightness modulation system, the output brightness level is designated, only depending on depth positions of the plurality of display objects, the depth positions each being defined at a position between or among the plurality of displaying devices. That is, the output brightness level is designated, so that it changes in a linear relationship with the depth position, regardless of whether or not the display object exists, or regardless of the contents thereof. On the contrary, according to the first display apparatus, the output brightness level is designated, depending on the contents of the display object in addition to the depth position thereof Basically, therefore, if the display objects exist on the view line unevenly, or if the contents thereof show variety, the output brightness level is designated to change basically in a non-linear relationship with the depth position. As used herein, the expression “the output brightness level changes in a “non-linear” manner (or relationship)” indicates that a change rate of the output brightness level is not constant to that of the depth position. On the contrary, as used herein, the expression “the output brightness level changes in a “linear” manner (or relationship)” indicates that a change rate of the output brightness level is constant to that of the depth position.

Therefore, a three dimensional effect of a stereoscopic image that is achieved by a plurality of images each having a predetermined or desired output brightness level can be controlled relatively easily, depending on the contents or depth position of the display objects. That is, it is possible to emphasize or not to emphasize a three-dimensional effect of a display object to be displayed in a stereoscopic image, or it is possible to achieve an appropriate three-dimensional effect depending on the contents of the display objects.

Conclusively, according to the first display apparatus, it is possible to designate a predetermined or desired output brightness level, depending on the contents of the display object and the depth position of the display object. Therefore, it is possible to display a stereoscopic image having a predetermined or desired three-dimensional effect, no matter what the contents of the display object are. Therefore, the observer can view a stereoscopic image having the optimal or appropriate three-dimensional effect.

Additionally, each size, brightness, color tone or focusing and so on of the plurality of images may be changed so that a perspective of a stereoscopic image is emphasized, or the stereoscopic image is displayed with shading. Thereby, an extent of three-dimensional effect in a stereoscopic image can be finely tuned.

In an aspect of the first display apparatus according to the present invention, the output level control device designates the output brightness level, so that a wide range of the output brightness level is assigned to an output video signal relating to a display object, among the plurality of display objects, to be emphasized in its three-dimensional effect.

According to this aspect, it is possible to display a stereoscopic image in which a three-dimensional effect relating to a predetermined display object of the plurality of display objects is emphasized. That is, in designation of the brightness level relating to the plurality of images of a display object, if an available range of the brightness level is relatively increased (i.e. if change rate of the brightness level distribution in displaying devices in tandem is relatively increased), the image is displayed as if it exists over a range from nearer side to farther side as seen from the observer. That is, it is possible to relatively emphasize the three-dimensional effect in the depth direction of the display object.

Thereby, if a display object to be emphasized in its three-dimensional effect is selected and the change rate of the brightness level distribution relating to this object, this object can be displayed with the emphasized three-dimensional effect.

In another aspect of the first display apparatus, the output level control device designates the output brightness level, so that a narrow range of the output brightness level is assigned to an output video signal relating to a display object, among the plurality of display objects, to be weakened in its three-dimensional effect.

According to this aspect, it is possible to display a stereoscopic image in which a three-dimensional effect relating to a predetermined display object of the plurality of display objects is weakened. That is, in designation of the brightness level relating to the plurality of images of a display object, if an available range of the brightness level is relatively decreased (i.e. if change rate of the brightness level distribution in displaying devices in tandem is relatively decreased), a range in the depth direction of the display object is relatively decreased. That is, it is possible to relatively weaken the three-dimensional effect in the depth direction of the display object. Additionally, designating the output brightness level without distributing thereof allows to display a predetermined display object as a background image (i.e. plane or two-dimensional image).

Thereby, if a display object to be weakened or not to be emphasized in its three-dimensional effect is selected, this object can be displayed with the weakened three-dimensional effect. Thereby, for example, the display objects other than the display object displayed with the weakened three-dimensional effect have an extent of three-dimensional effect comparable to a case that the effect is relatively emphasized.

In another aspect of the first display apparatus according to the present invention, the apparatus further comprises a parameter acquirement device for acquiring a display contents parameter indicating at least one contents of the plurality of display objects, wherein the output level control device designates the output brightness level, on the basis of the display contents parameter acquired by said parameter acquirement device.

According to this aspect, it is possible to display a stereoscopic image having more appropriate three-dimensional effect, depending on a value of the display contents parameter. The display contents parameter may indicate an extent of three-dimensional effect relating to each of the plurality of display objects, or may indicate any other display manner.

For example, then, if the display contents parameter indicates that a display object is to be displayed with an emphasized three-dimensional effect, the output level control device designates the output brightness level so as to emphasize the three-dimensional effect of the display object. On the other hand, if the display contents parameter indicates that a display object is to be displayed with a weakened three-dimensional effect, the output level control device designates the output brightness level so as to weaken the three-dimensional effect of the display object.

Therefore, it is relatively easy to control an extent of a three-dimensional effect relating to a display object, with reference to the display contents parameter.

The display contents parameter may be added in advance to an input video signal, or may be inputted into the display apparatus according to the invention separately from the input video signal. Furthermore, it may be generated by an author for generating an input video signal for a stereoscopic display, or may be generated independently by a user (or an observer) of the display apparatus.

The above object of the present invention is achieved by a second display apparatus comprising: a plurality of displaying devices disposed in tandem on a view line of an observer, for displaying a plurality of images relating to a plurality of display objects in an overlapped manner on the view line; a parameter acquirement device for acquiring a condition parameter indicating an observation condition under which a virtual observer observes the plurality of display objects, the virtual observer being assumed existing within a space in which the plurality of display objects are disposed; an output level control device for designating an output brightness level of each of the plurality of images, depending on both (i) a depth position of each of the plurality of display objects, the depth position being defined between or among the plurality of displaying devices and (ii) contents of each of the plurality of display objects; and an output level distribution device for distributing an input video signal for displaying the plurality of display objects, as an output video signal having the designated output brightness level, to each of the plurality of displaying devices.

According to the second display apparatus according to the present invention, similarly to the first display apparatus, the output level distribution device distributes output video signals each having the output brightness level designated by the output level control device, so that a stereoscopic image is displayed.

Particularly in the second display apparatus, there is provided with the parameter acquirement device for acquiring a condition parameter indicating an observation condition of a virtual observer who views a display object. The term “virtual observer” herein means a person who views virtually a display object in a space (or a virtual space) in which the display object is disposed. On the contrary, the term “observer” is intended to indicate a person who actually views a stereoscopic image obtained by means of a plurality of images displayed in an overlapped manner on the view line. That is, a display object seen (or shot) from a view point of a “virtual observer” is stereoscopically displayed, while an “observer” views the display object displayed stereoscopically. Incidentally, the “virtual observer” and the “observer” do not typically exist at the same position relative to a display object. Nevertheless, if the “observer” is an ideal observer, the “observer” and the “virtual observer” may exist at the same position. In this case, the “observer” may be equal to the “virtual observer”. Then, as discussed later, the condition parameter may include an observation position, a view line, a view range (or a viewing angle) of a virtual observer; a distance between an observer and a display object; or information about an extent of three-dimensional effect of a display object.

Then, the output level control device can designate more preferable output brightness level, on the basis of (i) contents of a condition parameter acquired by the parameter acquirement device and (ii) a depth position of a display object defined between or among the plurality of displaying devices.

Therefore, the output brightness level can be designated, taking also an observation condition of a virtual observer (or a observer in a case that he/she may be the virtual observer) into account, different from a conventional brightness modulation system in which the output brightness level is designated only depending on a depth position of the display object. Thereby, it is possible to display a stereoscopic image having a desired three-dimensional effect depending on the observation condition. Alternatively, it is possible to display a stereoscopic image having the optimal or more appropriate three-dimensional effect, depending on the observation condition. Thereby, it is possible to display a stereoscopic image having more appropriate three-dimensional effect, for example taking a perspective or the like of the observer into account.

Conclusively, according to the second display apparatus of the invention, it is possible to display a stereoscopic image having a predetermined or desired three-dimensional effect for which the observer's perspective is taken into account, depending on an observation condition of a virtual observer and a depth position of a display object for example. Therefore, the observer can view a stereoscopic image having the optimal or appropriate three-dimensional effect, no matter what the display object contents are.

Incidentally, also in the second display apparatus, similarly to the first display apparatus, size, brightness, color tone or focusing of each of the plurality of images and so on may be changed so that a perspective of a stereoscopic image is emphasized, for example.

In au aspect of the second display apparatus, the condition parameter includes at least one of (i) information relating to an observation position of the virtual observer, (ii) information relating to a distance between the virtual observer and at least one of the plurality of display objects, and (iii) information relating to a visual range of the virtual observer,

According to this aspect, the parameter acquirement device can acquire information relating to an observation position of a virtual observer who observes a display object (or display objects). Then, the output level control device can designate an appropriate output brightness level depending on the acquired observation position. Thereby, it is possible to display a stereoscopic image having a desired three-dimensional effect, depending on the virtual observer's position. That is, it is possible to change the three-dimensional effect sensed by the observer.

Furthermore, according to this aspect, the parameter acquirement device can acquire information relating to a distance between (i) a virtual observer who observes a display object (or display objects) and (ii) at least one of the plurality of display objects. Then, the output level control device can designate an appropriate output brightness level depending on the acquired distance. Thereby, it is possible to display a stereoscopic image having a desired three-dimensional effect, depending on the distance between the virtual observer and the display object.

Furthermore, according to this aspect, the parameter acquirement device can acquire information relating to a visual range of a virtual observer who observes a display object (or display objects). Then, the output level control device can designate an appropriate output brightness level depending on the acquired visual range. Thereby, it is possible to a stereoscopic image having a desired three-dimensional effect, on the basis of the visual range of the virtual observer.

In another aspect of the second display apparatus, the output level control device designates the output brightness level, so that a wide range of the output brightness level is assigned to an output video signal relating to a display object, among the plurality of display objects, to be emphasized in its three-dimensional effect, and so that a narrow range of the output brightness level is assigned to an output video signal relating to a display object, among the plurality of display objects, to be weakened in its three-dimensional effect.

According to this aspect, in the case that a three-dimensional effect is to be emphasized in response to (i) a depth position of the display object and (ii) a condition parameter, a relatively wide range of an available brightness is assigned. More specifically, the brightness is assigned so that a change rate of an assignment ratio (i.e. a front-rear ratio of a brightness level between two displaying devices) becomes relatively large. On the other hand, in the case that a three-dimensional effect is to be weakened in response to (i) a depth position of the display object and (i) a condition parameter, a relatively narrow range of an available brightness is assigned. More specifically, the brightness is assigned so that a change rate of an assignment ratio (i.e. a front-rear ratio of a brightness level between tow displaying devices) becomes relatively small.

According to the inventors' study, it is shown that an image with a stronger three-dimensional effect (i.e., wide range in the depth direction) can be displayed, if the change rate of the brightness assignment is relatively large. Therefore, the observer can view a stereoscopic image having more appropriate three-dimensional effect, on the basis of an observation condition of a virtual observer (i.e. an observation parameter).

In another aspect of the first or second display apparatus according to the present invention, the output level control device designates the output brightness level, so that the output brightness level changes in a non-linear manner relative to the depth position.

According to this aspect, it is possible to control whether or not a three-dimensional effect of a display object is to be emphasized, in response to a change rate of a brightness level in non-linear region, in which the brightness level changes in non-linear manner to the depth position That is, the larger a change rate of a brightness level in the non-linear region becomes, the more the three-dimensional effect is emphasized. On the other hand, the smaller a change rate in the non-linear region becomes, the more the three-dimensional effect can be weakened. Otherwise, an appropriate three-dimensional effect can be achieved, by designating an output brightness level changing in a non-linear manner, even in the case that the plurality of display objects exists unevenly on the view line.

In another aspect of the first or second display apparatus according to the present invention, the output level control device designates the output brightness level so that the output brightness level relating to the plurality of images about one display object changes in a linear manner relative to the depth position within a range portion in which said one display object exists, the range portion being a part of a depth range that is a range in a depth direction along the view line and in which the plurality of display objects exist.

According to this aspect, it is possible to control the three-dimensional effect, so that a constant three-dimensional effect is applied to each range portion in the depth direction. That is, it is possible to control whether or not a three-dimensional effect of a display object, which exists within each range portion of the depth direction, is to be emphasized relative to another display object among the plurality of display objects, avoiding a distortion or contortion in the depth direction.

In another aspect of the first or second display apparatus according to the present invention, the output level control device designates the output brightness level, so that the output brightness level relating to the plurality of images about at least one display object changes in a linear manner relative to the depth position within a range portion in which the plurality of display objects including said at least one display object exist, the range portion being a part of a depth range that is a length in a depth direction along the view line and in which the plurality of display objects exist, and so that the output brightness level relating to the plurality of images about at least another one display object changes in a non-linear manner relative to the depth position within another range portion in which the plurality of display objects including said at least another one display object exist, said another range, portion being a part of the depth range.

According to this aspect, a combination of a linear change and a non-linear change enables a stereoscopic image, for every range portion, to be displayed with an emphasized or not-emphasized three-dimensional effect relating to a display object existing in each range portion. Therefore, a stereoscopic display can be achieved with more appropriate three-dimensional effect.

In another aspect of the first or second display apparatus, the output level control device designates the output brightness level, so that the output brightness level with regard to a part of the plurality of display objects to be displayed frontward as seen from the observer decreases monotonously in proportion to an increase of a value indicating the depth position (i.e. an increase of the depth position), and so that the output brightness level with regard to a part of the plurality of display objects to be displayed rearward as seen from the observer increases monotonously in proportion to an increase of the value indicating the depth position.

According to this aspect, it is possible to control whether or not the three-dimensional effect is to be emphasized, without reversing relative relationships in the depth direction among the plurality of display objects, relative to the natural or original relationships. That is, it is possible to emphasize a three-dimensional effect of a specific display object in a natural stereoscopic display.

In another aspect of the first or second display apparatus according to the present invention, the input video signal is added with depth information indicating the depth position with regard to at least one display object of the plurality of display objects.

According to this aspect, for example, the output level control device can designate the output brightness level relatively easily, with reference to the depth information. That is, it is possible to distribute the brightness level (i.e. designate the brightness level) in the plurality of images, as if each image exists at a position depending on a depth position of each display object.

Incidentally, the depth information may be inputted into the display apparatus as a signal independently of the input video signal, even if the depth information is not included in the input video signal

In another aspect of the first or second display apparatus according to the present invention, the output level control device designates the output brightness level, on the basis of a pre-set function.

According to this aspect, the output level control device can designate the output brightness level relatively easily, by performing a calculation based on the pre-set function. For example, a function may be used, in which the depth position of the display object is input, and the output brightness level is output.

In another aspect of the first or second display apparatus, the output level control device designates the output brightness level, on the basis of a pre-set table.

According to this aspect, the output level control device can designate the output brightness level relatively easily, on the basis of a relationship defined by the pre-set table. For example, a table may be used, in which a relationship between the depth position of the display object and the output brightness level is indicated.

In another aspect of the first or second display apparatus according to the present invention, the apparatus is provided with an external input device for inputting an external parameter to externally designate the output brightness level, and the output level control device designates the output brightness level, on the basis of the external parameter.

According to this aspect, the observer can designate a desired brightness level. Therefore, it is possible to display a stereoscopic image with an observer-desired three-dimensional effect.

Incidentally, according to this aspect, it may be arranged so that at least one of the aforementioned display contents parameter and condition parameter can be inputted. In this arrangement, it is also possible to display a stereoscopic image having an observer-desired three-dimensional effect, by inputting the display contents parameter or condition parameter.

In another aspect of the first or second display apparatus according to the present invention, each of the plurality of displaying devices can be controlled for each pixel, the output level control device designates the output brightness level for each pixel, and the output level distribution device distributes the output video signal for each pixel.

According to this aspect, it is possible to designate the output brightness level for each pixel. Then, it is possible to distribute the output brightness level as an output video signal whose output brightness level is designated for each pixel, into a plurality of displaying devices respectively. Therefore, it is possible to display a stereoscopic image with a further fine-tuned three-dimensional effect.

Incidentally, the output brightness level may be designated for each pixel block comprising a plurality of pixels, so that the output brightness level is distributed as an output video signal whose output brightness level is designated for each pixel block, into a plurality of displaying devices respectively. Also in this case, it is possible to display a stereoscopic image with a satisfactorily fine-tuned three-dimensional effect.

The above object of the present invention is achieved by a third display apparatus provided with: a dividing device for dividing a depth range that is a range in a depth direction of a stereoscopic display image including a plurality of display objects into a plurality of range portions each having a desired range; a parameter providing device for providing a three-dimensional effect parameter to each of the plurality of range portions, the three-dimensional effect parameter indicating an extent of three-dimensional effect in the depth direction to be applied on at least one of the plurality of display objects existing in one of the plurality of range portions, depending on both (i) contents of said at least one of the plurality of display objects and (ii) a depth position of said at least one of the plurality of display objects; and a displaying device for displaying stereoscopically said at least one of the plurality of display objects, so that the extent of three-dimensional effect indicated by the three-dimensional effect parameter is applied thereon.

According to the third display apparatus, it is possible to display each of the plurality of display objects each with a desired or predetermined three-dimensional effect.

More specifically, the dividing device divides an entire length of the depth range, in which the plurality of display objects exist, into a plurality of range portions each having a desired length. Each range portion may have the same length to each other, or may have a different length from each other.

Then, the parameter providing device provides at least one of the display objects existing in each range portion divided by the dividing device with a three-dimensional effect parameter indicating an extent of three-dimensional effect of the at least one of the display objects, as for each range portion. The parameter providing device preferably provides a three-dimensional effect parameter indicating an extent of three-dimensional effect, depending on a depth position and contents of at least one display object. Incidentally, the three-dimensional effect parameter provided by the parameter providing device may include information indicating to which extent three-dimensional effect is to be emphasized (e.g. what length of depth range from among the entire length can provide a three-dimensional effect of a display object), or may include information indicating an instruction to display a display object in two-dimension without a three-dimensional effect being provided.

Then, in response to the three-dimensional effect parameter provided by the parameter providing device, the displaying device stereoscopically displays at least one display object existing in the selected range portion. For this, the displaying device preferably displays stereoscopically the at least one display object, so that a three-dimensional effect can be obtained at an extent defined by the three-dimensional effect parameter provided by the parameter providing device. Then, the extent of three-dimensional effect may be controlled by changing size, brightness, color tone or focusing of the display object for example.

Therefore, a display object is stereoscopically displayed with a predetermined three-dimensional effect defined by the three-dimensional parameter, for each range portion having a desired length. That is, depending on the contents of the display object, more appropriate three-dimensional effect can be applied. Therefore, with an efficient use of the depth range having a limitation in its length, a stereoscopic display can be performed emphatically for a display object desired its stereoscopic display, or a stereoscopic display with a priority can be achieved for a display object desired its stereoscopic display.

Conclusively, according to the third display apparatus, it is possible to display at least one display object existing in each of the divided range portions with an emphasized or not-emphasized three-dimensional effect. That is, depending on the contents of the display object and the depth position of the display object for example, it is possible to display the display object as a stereoscopic image having more appropriate three-dimensional effect, for example, for each range portion having a desired length. Therefore, the observer can view a stereoscopic image having the optimal or appropriate three-dimensional effect, no matter what the contents of the display object are.

Incidentally, similarly to the second display apparatus, the parameter providing device may be arranged to provide a three-dimensional effect parameter indicating an extent of a three-dimensional effect in the depth direction to be applied on at least one display object for each range portion, depending on (i) a depth position of the at least one display object among the plurality of display objects existing in one of the plurality of range portion, and (ii) an observation condition when the virtual observer observes the at least one display object.

Also in this arrangement, it is possible to display a stereoscopic image having an appropriate three-dimensional effect depending on the observation condition.

In one aspect of the third display apparatus according to the present invention, the displaying device displays entirely the stereoscopic display image, by displaying a plurality of images each relating to the plurality of display objects and disposed in tandem on a view line of an observer along the depth direction, the plurality of images being displayed in an overlapped manner on the view line, the parameter providing device provides the three-dimensional effect parameter to at least one of the plurality of display objects, by (i) designating an output brightness level for each of the plurality of images on the basis of the depth position and the contents, and (ii) distributing output video signals having the designated output brightness level as for the at least one of the plurality of display objects into each of the plurality of displaying devices.

According to this aspect, an appropriate stereoscopic display can be achieved particularly in a brightness modulation type of stereoscopic display system, since the parameter providing device designates the output brightness level for each of the plurality of images for the stereoscopic display, and distributes output video signals. That is, the observer can view a stereoscopic image having more appropriate three-dimensional effect, since each of the plurality of images for the stereoscopic display, to which the brightness level is designated or distributed appropriately, is displayed respectively on each of the plurality of displaying devices.

Incidentally, the third display apparatus can also take various aspects, corresponding to various aspects of the first or second display apparatus.

In at least one aspect of the first, second and third display apparatus, the plurality of display devices, other than at least one thereof disposed at the rearmost position as seen from the observer, is/are semi transparent.

According to this aspect, it is possible for the observer to view an image displayed on a displaying device disposed rearmost and behind other displaying devices, which are disposed frontward, through these other displaying devices disposed frontward as seen from the observer. These displaying devices can be disposed on a view line of the observer.

In the aspect of the display apparatus including the semi-transparent displaying device as mentioned above, the semi-transparent displaying device may comprise a LCD or EL display device.

In this arrangement, it is possible to display a stereoscopic image by means of the semi-transparent panel-like displaying device, such as the LCD or EL display device.

In at least one aspect of the first, second and third display apparatus according to the present invention, the plurality of displaying devices include a displaying device which displays the image for the stereoscopic display synthesized by a half mirror with the images displayed on,the another displaying devices of the plurality of the displaying devices.

According to this aspect, at least one displaying device among the plurality of displaying device is not disposed directly on the observer's view line, but a image is synthesized by means of the half mirror with the images displayed on the another displaying devices among the plurality of the displaying devices. Therefore, it is possible to use any displaying device without a light transmission property, such as CRT display device, PDP device, FED device and so on.

Incidentally, the displaying device, which displays the image synthesized by the half mirror with the images displayed on the another displaying devices, may take the aforementioned various aspects, under an assumption that an image surface on which an image is viewed by the observer on his/her view line is assumed as a displaying device to be disposed on the observer's view line.

The above object of the present invention is achieved by a first display method implemented with a display apparatus provided with a plurality of displaying devices disposed in tandem on a view line of an observer, for displaying a plurality of images relating to a plurality of display objects in an overlapped manner on the view line, the display method comprising: an output level control process of designating an output brightness level of each of the plurality of images, depending on both (i) a depth position of each of the plurality of display objects, the depth position being defined between or among the plurality of displaying devices and (ii) contents of each of the plurality of display objects; and an output level distribution process of distributing an input video signal for displaying the plurality of display objects, as an output video signal having the designated output brightness level, to each of the plurality of displaying devices.

According to the first display method, similarly to the first display apparatus mentioned above, at the output level control process, an output brightness level is designated, depending on contents of a display object. And at the output level distribution process, an input video signal is distributed into a plurality of displaying devices respectively, as an output video signal having the designated output brightness level. Thereby, a predetermined or desired output brightness level can be designated, depending on the contents of the display object. Therefore, it is possible to display a stereoscopic image having a predetermined or desired three-dimensional effect, no matter what the contents of the display object are. Therefore, the observer can view a stereoscopic image having the optimal or appropriate three-dimensional effect.

Incidentally, the first display method can also take various aspects, corresponding to various aspects of the first display apparatus mentioned above.

The above object of the present invention is achieved by a second display method implemented with a display apparatus provided with a plurality of displaying devices disposed in tandem on a view line of an observer, for displaying a plurality of images relating to a plurality of display objects in an overlapped manner on the view line, the display method comprising: a parameter acquirement process of acquiring a condition parameter indicating an observation condition under which a virtual observer observes the plurality of display objects, the virtual observer being assumed existing within a space in which the plurality of display objects are disposed; an output level control process of designating an output brightness level of each of the plurality of images, depending on both (i) a depth position of each of the plurality of display objects, the depth position being defined between or among the plurality of displaying devices and (ii) contents of each of the plurality of display objects; and an output level distribution process of distributing an input video signal for displaying the plurality of display objects, as an output video signal having the designated output brightness level, to each of the plurality of displaying devices.

According to the second display method, similarly to the second display apparatus mentioned above, a condition parameter is acquired at the parameter acquirement process. Then, at the output level control process, an output brightness level is designated, in response to the condition parameter. And at the output level distribution process, an input video signal is distributed into the plurality of displaying devices, as an output video signal having the designated output brightness level. Thereby, it is possible to display a stereoscopic image having a predetermined or desired three-dimensional effect, depending on an observation condition of the virtual observer, for example, taking an observer's perspective into account. Therefore, the observer can view a stereoscopic image having the optimal or appropriate three-dimensional effect, no matter what the contents of the display object are.

Incidentally, the second display method can also take various aspects, corresponding to various aspects of the second display apparatus mentioned above.

The above object of the present invention is achieved by a third display method provided with: a dividing process of dividing a depth range that is a range in a depth direction of a stereoscopic display image including a plurality of display objects into a plurality of range portions each having a desired range; a parameter providing process of providing a three-dimensional effect parameter to each of the plurality of range portions, the three-dimensional effect parameter indicating an extent of three-dimensional effect in the depth direction to be applied on at least one of the plurality of display objects existing in one of the plurality of range portions, depending on both (i) contents of the at least one of the plurality of display objects and (ii) a depth position of the at least one of the plurality of display objects; and a displaying process of displaying stereoscopically the at least one of the plurality of display objects, so that the extent of three-dimensional effect indicated by the three-dimensional effect parameter is applied thereon.

According to the third display method, similarly to the third display apparatus mentioned above, at the dividing process, the entire length of depth range is divided into a plurality of range portions. And at the parameter providing process, a three-dimensional effect parameter is assigned to each divided range portion. Then, at the displaying process, the display object is stereoscopically displayed, so that the extent of three-dimensional effect indicated by the three-dimensional effect parameter is applied thereon, Thereby, it is possible to display a stereoscopic image having more appropriate three-dimensional effect, for example for each range portion having a desired length, depending on, for example, the contents of the display object and the depth position of the display object. Therefore, the observer can view a stereoscopic image having the optimal or appropriate three-dimensional effect, no matter what the contents of the display object are.

Incidentally, the third display method can also take various aspects, corresponding to various aspects of the third display apparatus mentioned above.

As discussed above, the first display apparatus is provided with: the output level control device; and the output level distribution device. On the other hand, the second display apparatus is provided with: the parameter acquirement device; the output level control device; and the output level distribution device. On the other hand, the third display apparatus is provided with: the dividing device; the parameter providing device; and the displaying device. On the other hand, the first display method is provided with: the output level control process; and the output level distribution process. On the other hand, the second display method is provided with: the parameter acquirement process; the output level control process; and the output level distribution process. On the other hand, the third display method is provided with: the dividing process; the parameter providing process; and the displaying process.

Thereby, it is possible to display a stereoscopic image having a predetermined or desired three-dimensional effect, depending on the contents of the display object or the observation condition of a virtual observer (or the observation condition or perspective of an observer in the case that the observer can be treated as the same as the virtual observer). Therefore, the observer can view a stereoscopic image having the optimal or appropriate three-dimensional effect, no matter what the contents of the display object are.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram illustrating a construction of the first embodiment of the display apparatus according to the present invention.

FIG. 2 is a schematic cross section of an optical system illustrating another construction of an image display portion of the first embodiment of the display apparatus according to the present invention.

FIG. 3 is a flow chart illustrating an operational flow of the first embodiment of the display apparatus according to the present invention.

FIG. 4 is a schematic view conceptually illustrating a specific example of an image displayed in the first embodiment of the display apparatus according to the present invention.

FIG. 5 is a schematic view conceptually illustrating a “depth in percent” of the image shown in FIG. 4 in the first embodiment of the display apparatus according to the present invention.

FIG. 6 is a graph illustrating an example of a specific relationship between the depth in percent and the distribution rate in percent, with a corresponding specific example of the image shown in FIG. 4.

FIG. 7 is a graph illustrating a comparative example of a relationship between the depth in percent and the distribution rate in percent, with a corresponding specific example of the image shown in FIG. 4.

FIG. 8 is a graph illustrating another specific example of the relationship between the depth in percent and the distribution rate in percent, in the first embodiment of the display apparatus according to the present invention.

FIG. 9 is a graph illustrating another specific example of the relationship between the depth in percent and the distribution rate in percent, in the first embodiment of the display apparatus according to the present invention.

FIG. 10 is a graph illustrating another specific example of the relationship between the depth in percent and the distribution rate in percent, in the first embodiment of the display apparatus according to the present invention.

FIG. 11 is a graph illustrating another specific example of the relationship between the depth in percent and the distribution rate in percent, in the first embodiment of the display apparatus according to the present invention

FIG. 12 is a graph illustrating another specific example of the relationship between the depth in percent and the distribution rate in percent, in the first embodiment of the display apparatus according to the present invention.

FIG. 13 is a graph illustrating another specific example of the relationship between the depth in percent and the distribution rate in percent, in the first embodiment of the display apparatus according to the present invention.

FIG. 14 is a graph illustrating another specific example of the relationship between the depth in percent and the distribution rate in percent, in the first embodiment of the display apparatus according to the present invention.

FIG. 15 is a graph illustrating another specific example of the relationship between the depth in percent and the distribution rate in percent, in the first embodiment of the display apparatus according to the present invention.

FIG. 16 is a block diagram illustrating a construction of the second embodiment of the display apparatus according to the present invention.

FIG. 17 is a flow chart illustrating an operational flow of the second embodiment of the display apparatus according to the present invention.

### DETAILED DESCRIPTION OF THE PREFERRED EMBODIMENTS

Now, embodiments of the display apparatus according to the present invention will be discussed, with reference to drawings.

### First Embodiment

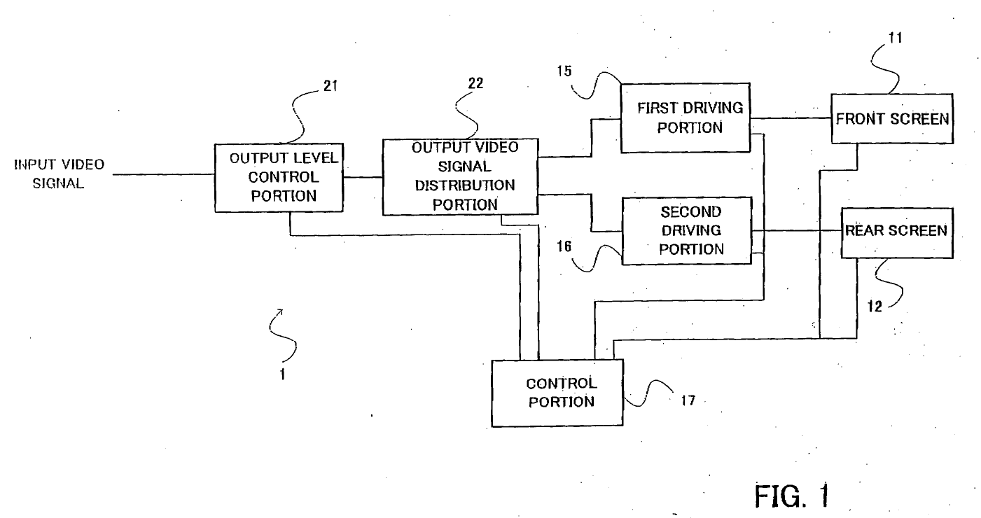

The embodiments of the display apparatus according to the present invention will now be discussed, with reference to FIG. 1 to FIG. 17.

### Fundamental Construction of First Embodiment

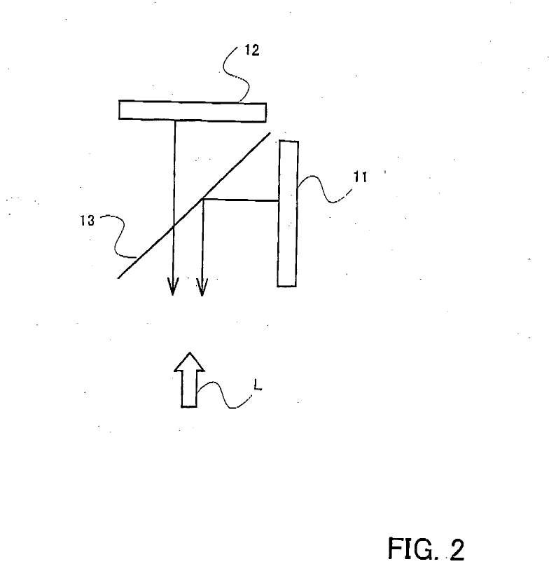

Firstly, with reference to FIG. 1, the fundamental construction of the first embodiment of the display apparatus according to the present invention will now be discussed. FIG. 1 is a block diagram illustrating a fundamental construction of the first embodiment of the display apparatus according to the present invention. FIG. 2 is a schematic cross section of an optical system illustrating another construction of an image display portion of the first embodiment of the display apparatus according to the present invention.

As shown in FIG. 1, the display apparatus 1 is provided with: a front screen 11; a rear screen 12; a first driving portion 15; a second driving portion 16; a control portion 17; an output level control portion 21; and an output video signal distribution portion 22.

The front screen 11 and the rear screen 12 form an image display portion of the display apparatus 1, and are disposed with a predetermined distance from each other in a direction of an observer's view line L. The front screen 11 is disposed forward, while the rear screen 12 is disposed rearward, A light transmissive displaying device such as an LCD (Liquid Crystal Display) device or EL (Electroluminescence) displaying device is employed as the front screen 11, so that the observer can view an image on the rear screen 12, which is disposed rearward of the front screen 11, through the front screen11. On the other hand, the rear screen 12 to be disposed rearward may be an LCD device or an EL displaying device, or may be CRT (Cathode Ray Tube) displaying device or PDP (Plasma Display Panel) device, because the light transmissive property is not required for the rear screen.

It is possible to display a stereoscopic image, as if it exists between the front screen 11 and the rear screen 12, by controlling (e.g. increasing or decreasing) the brightness of the front screen 11 and the brightness of the rear screen 12, respectively That is, a brightness modulation type of stereoscopic image display can be presented.

Incidentally, in addition to the LCD displaying device or the EL displaying device, a CRT displaying device or a PDP device without the light transmissive property may be employed as the front screen 11. That is, as shown in FIG. 2, the front screen 11 is disposed so that it does not obstruct the observer's view line L to the rear screen 12, while a half mirror 13 is disposed on the observer's view line L, at an angle so that an image on the front screen 11 is overlapped with an image on the rear screen 12. Owing to this construction, the displaying device without the light transmissive property can be employed as the image display portion.

As shown in FIG. 1, the first driving portion 15 and the second driving portion 16 are for driving the front screen 11 and the rear screen 12, respectively, so that an image is displayed on each screen, on the basis of a video signal divided by the output video signal distribution portion 22 for the front screen 11 or the rear screen 12. The first driving portion 15 and the second driving portion 16 may have a feature for displaying an image decoratively and effectively such as a display with flashing, a display with a preferred or predetermined timing, under control of the control portion 17.

The control portion 17 controls entirely the display apparatus 1. As for a stereoscopic image display, a display condition of the front screen 11 and the rear screen 12, such as brightness or scale, may be adjusted.

The output level control portion 21 controls the output brightness level of an “image indicated by the input video signal” (hereinafter referred to as an “input image”), in response to the contents of the input image. More specifically, a distribution curve of the brightness is designated, as discussed later.

Furthermore, the output level control portion 21 is preferably capable of designating a predetermined distribution rate (or distribution factor), depending on a depth position of the input image. Additionally, the distribution rate is preferably designated for each pixel of the front screen 11 and the rear screen 12, respectively.

The output video signal distribution portion 22 divides the input video signal into an output video signal for the front screen 11 and an output video signal for the rear screen 12, at an output brightness level designated by the output level control portion 21, and then outputs the output video signal for the front screen 11 to the first driving portion 15 and the output video signal for the rear screen 12 the second driving portion 16, respectively.

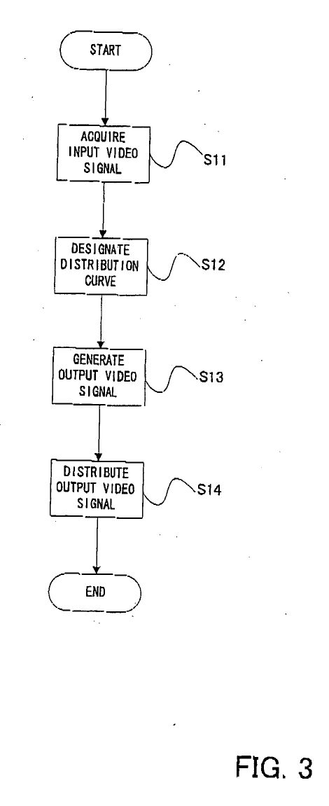

According to the display apparatus 1 discussed above, a stereoscopic image with a desired or predetermined a three-dimensional effect can be displayed in accordance with the contents of the image to be displayed, as if it exists between the front screen 11 and the rear screen 12. Incidentally, these detail operation or function is explained below (see FIG. 3).

### Exemplary Operation of First Embodiment

Next, with reference to FIG. 3 to FIG. 15, an exemplary operation of the first embodiment of the display apparatus according to the present invention is explained.

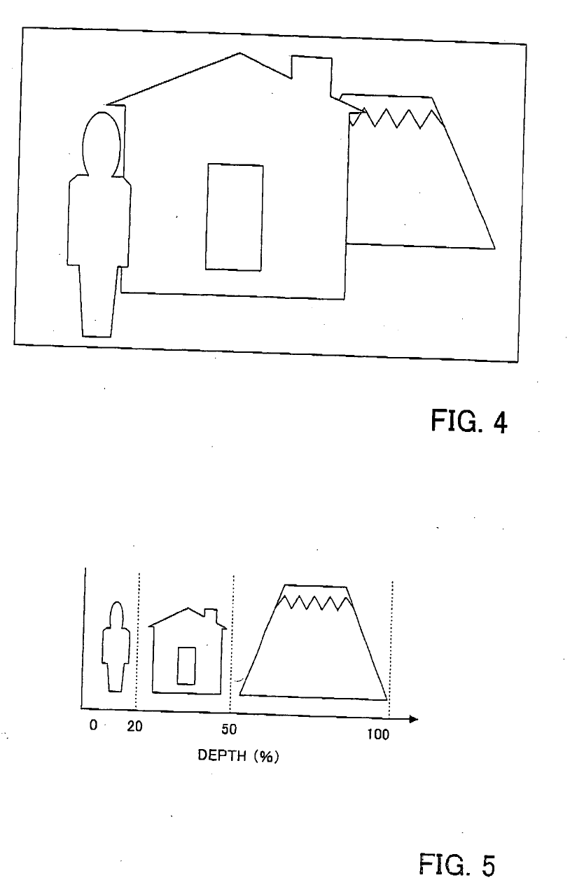

Firstly, with reference to FIG. 3 to FIG. 5, a fundamental operation of an embodiment of the display apparatus according to the present invention is displayed. FIG. 3 is a flow chart illustrating an operational flow of the first embodiment of the display apparatus according to the present invention. FIG. 4 is a schematic view conceptually illustrating a specific example of an image displayed by the first embodiment of the display apparatus. FIG. 5 is a schematic view conceptually illustrating a “depth in percent” of the image shown in FIG. 4.

Incidentally, the “depth in percent” herein refers to a position at which the three-dimensional effect of the image is obtained. For example, 0% of the depth in percent means that the three-dimensional effect is obtained at the position of the front screen 11. In other words, observer can view the image as if it exists at the front screen 11. While 100% of the depth in percent means that the three-dimensional effect is obtained at the position of the rear screen 12. In other words, observer can view the image as if it exists at the rear screen 12. Furthermore, 50% of the depth in percent means that the three-dimensional effect is obtained at an intermediate position between the front screen 11 and the rear screen 12. In other words, observer can view the image as if it exists at the intermediate position between the front screen 11 and the rear screen 12.

As shown in FIG. 3, the output level control portion 21 acquires an input video signal indicating an image to be stereoscopically displayed (step S11). The input video signal may be obtained by reading it from a record medium, such as a CD-ROM, a DVD-ROM, a hard disk or floppy disk®, or may be obtained by downloading it via a network such as Internet.

More specifically, for example, an input video signal indicating an image (i.e. an input image) as shown in FIG. 4 is acquired. As shown in FIG. 4, the input image indicates objects to be displayed (e.g. a man, a house and a mountain). In this input image, these objects are displayed in an order of man, house and mountain, as seen from the frontward (i.e. from the observer's side). Furthermore, the input image preferably includes depth information indicating the depth position (e.g. depth in percent) for each pixel of the front screen 11 and the rear screen12 on which the input image (actually, images for the three-dimensional display) is displayed.

Now assume that the input image shown in FIG. 4 includes depth information (depth in percent) as shown in FIG. 5. That is, a man part of the input image has depth information indicating that the three-dimensional effect is obtained at a position within a range of 0%-20% depth, a house part of the input image has depth information indicating that the three-dimensional effect is obtained at a position within a range of 20%-50% depth, and a mountain part of the input image has depth information indicating that the three-dimensional effect is obtained at a position within a range of 50%-100% depth. Incidentally, the depth information may indicate a coordinates value in a depth direction.

In FIG. 3 again, the output level control portion 21 designates a predetermined distribution curve corresponding to the input video signal obtained at the step S11 (step S12). The “distribution curve” herein means a curve (or a straight line, otherwise a combination of them) indicating a relationship between i) an assignment degree of the output brightness level (i.e. a distribution rate of brightness) for each object part of the image, among the front screen 11 and the rear screen 12, and (ii) a predetermined depth information relating to the input video signal. Furthermore, the “distribution curve” may be designated by a predetermined function in which the depth information is input and the distribution rate is output. The “distribution rate” means a rate of the output brightness level of images for stereoscopic display to be displayed on the front screen 11 or the rear screen 12, to the brightness level of the input image for example (or an input video signal or a video signal from which an image for stereoscopic display is generated).

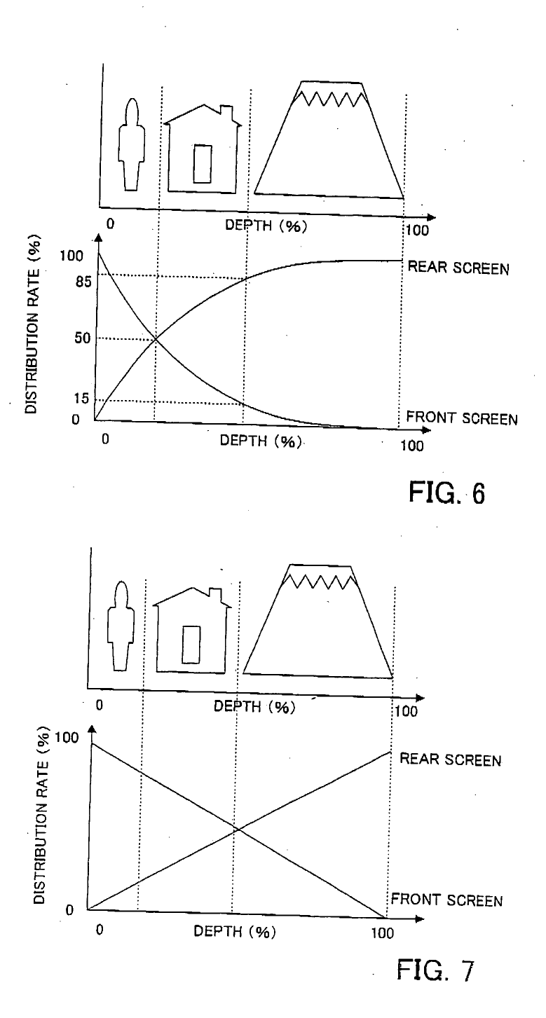

The output level control portion 21 designates a distribution curve shown in FIG. 6, for example, in accordance with the contents of the object to be displayed as discussed later, and outputs the designated distribution curve to the output video signal distribution portion 22. The output video signal distribution portion 22 generates images for stereoscopic display for the front screen 11 and the rear screen 12, on the basis of the distribution curve designated at the step S12. That is, it generates (i) an output video signal indicating an image for stereoscopic display for the front screen 11 with an output brightness level specified by the distribution curve (or the distribution rate) designated at the step S12, and (ii) an output video signal indicating an image for stereoscopic display for the rear screen 12 with an output brightness level specified by the distribution curve (or the distribution rate) designated at the step S12 (step S13).

Then, the output video signal distribution portion 22 outputs the output video signal, which makes an image for the stereoscopic display to be displayed on the front screen 11, generated at the step S13 to the first driving portion 15 and outputs the video signal, which makes an image for the stereoscopic display to be displayed on the rear screen 12, the second driving portion 16, respectively (step S14).

Thereby, each image with the suitably controlled brightness is displayed on the front screen 11 and the rear screen 12 respectively, so that the observer can view a stereoscopic image.

Next, with reference to FIG. 6, the distribution curve designated at the step S12 is explained. FIG. 6 is a graph illustrating an example of a specific relationship between the depth in percent and the distribution rate in percent, and illustrating also a relationship between the graph and the image shown in FIG. 4.

As shown in FIG. 6, the distribution curve indicates a distribution rate in percent to the depth in percent of each input image. The distribution curve includes a first distribution curve indicating a distribution rate of an image to be displayed on the front screen 11 and a second distribution curve indicating a distribution rate of an image to be displayed on the rear screen 12.

For example, in order to generate an image to be displayed on the front screen 11, the “man part of the image” of 0-20% depth in the input image is assigned with 100-50% output brightness level relative to the brightness level of the input video signal, depending on the depth position. For example, the “house part of the image” with 20-50% depth in the input image is assigned with 50-15% output brightness level, depending on the depth position. For example, the “mountain part of the image” with 50-100% depth in the input image is assigned with 15-0% output brightness level, depending on the depth position. In any case, the deeper the depth (i.e. as a part of image exists a deeper position), the smaller the distribution rate and thereby the output brightness level.

Therefore, an image for stereoscopic display for the front screen 11 is generated with a brightness suitably controlled depending on the depth position. That is, a part of the input image assigned with a relatively high distribution rate is displayed in a manner that the brightness changes within a wide range. On the other hand, a part of the input image assigned with a relatively low distribution rate is displayed in a manner that the brightness changes within a narrow range.

On the other hand, in order to generate an image to be displayed on the rear screen 12, the “man part of the image” with 0-20% depth in the input image is assigned with 0-50% output brightness level to the brightness level of the input video signal, depending on the depth position. For example, the “house part of the image” with 20-50% depth in the input image is assigned with 50-85% output brightness level, depending on the depth position. For example, the “mountain part of the image” with 50-100% depth in the input image is assigned with 85-100% output brightness level, depending on the depth position. In any case, the deeper the depth (i.e. as a part of image exists a deeper position), the bigger the distribution rate and thereby the output brightness level. Therefore, an image for stereoscopic display for the rear screen 12 is generated with a brightness suitably controlled depending on the depth position.

Then, each image for stereoscopic display is displayed on the front screen 11 and the rear screen 12, respectively, so that the observer can view a stereoscopic, image.

Particularly, if an image for stereoscopic display is generated on the basis of the distribution curve (or curves) shown in FIG. 6, an image for stereoscopic display is obtained so that the brightness of the “man part of the image” changes within a wide range (i.e. the distribution rate changes within a wide range), and the brightness of the “mountain part of the image” changes within a narrow range (i.e. the distribution rate change within a narrow range). If the distribution rate changes within a wide range, the part of the image is displayed as if it exists within a wider range from more frontward to more rearward. Therefore, the observer views the “man part of the image” as an image with a wider depth range (i.e. as an image with the stronger three-dimensional effect). More specifically, the three-dimensional effect is obtained at any depth position within an about 0-50% range of the depth, depending on the change in the brightness (i.e. the change in the distribution rate). That is, assigning the brightness appropriately on the basis of the distribution curve shown in FIG. 6 allows to emphasize the three-dimensional effect of the “man part of the image”, whose three-dimensional effect is originally obtained at any depth position within a 0-20% range of the depth without the distribution curve shown in FIG. 6 (refer to FIG. 7).

On the other hand, the observer views the “mountain part of the image” as an image with a narrower depth range (i.e. an image with a weakened three-dimensional effect). More specifically, the three-dimensional effect is obtained at any depth position within an about 85-100% range of the depth, depending on the change in the distribution rate. That is, assigning the brightness appropriately on the basis of the distribution curve shown in FIG. 6 allows to weaken the three-dimensional effect of the “mountain part of the image”, whose three-dimensional effect is originally obtained at any depth position within a 50-100% range of the depth without the distribution curve shown in FIG. 6 (refer to FIG. 7).

Now, a case that another distribution curve exemplarily shown in FIG. 7 is employed, instead of the distribution curve shown in FIG. 6, is explained as a comparative example. FIG. 7 is a graph illustrating a comparative example of a relationship between the depth in percent and the distribution rate in percent, and illustrating a relationship between the graph and the image shown in FIG. 4.

As shown in FIG. 7, in the comparative example, a distribution curve is designated, in which the depth in percent and the distribution rate in percent are in a linear relationship. And an image for stereoscopic display is generated on the basis of this distribution curve.

Thereby, the man, the house and the mountain indicated in the input image do not change their depth relationship, and therefore they are displayed as a stereoscopic image. Therefore, the observer views an image in which the “mountain part of the image” has the three-dimensional effect big in a depth direction and the “man part of the image” has the three-dimensional effect small in a depth direction”. More specifically, the “man part of the image” can obtain the three-dimensional effect at any depth position within a 0-20% of the depth, while “the mountain part of the image” can obtain the three-dimensional effect at any depth position within a 50-100% range of the depth. Therefore, the observer views a stereoscopic image in which the “man part of the image” has less three-dimensional effect than that of the “mountain part of the image”. In other words, the observer views a stereoscopic image having a rather excess level of the three-dimensional effect for the “mountain part of the image”.

Designating the distribution curve shown in FIG.6, however, allows to display a stereoscopic image having an appropriate level or extent of the three-dimensional effect, depending on the contents of the input image. That is, this serves a great advantage that an appropriate three-dimensional effect is given to the “man part of the image”, and thereby the observer can view a stereoscopic image having more appropriate three-dimensional effect.

Incidentally, the input video signal may have a display contents parameter, in order to designate a desired distribution curve by the output level control portion 21. If this display contents parameter is a display contents parameter of the input-video signal relating to the image shown in FIG. 4, it may indicate to emphasize the three-dimensional effect of the “man part of the image”, and to weaken the three-dimensional effect of the “mountain part of the image”. That is, the display contents parameter preferably includes information, from which the three-dimensional effect for the input image can be specified (e.g. emphasizing the three-dimensional effect of a predetermined image part). Alternatively, it may be an output level parameter, from which a distribution curve can be designated directly or indirectly. That is, it preferably includes information, from which the distribution curve to designate the output brightness level can be specified.

The Display contents parameter or output level parameter may be added to the input video signal, or may be inputted to the display apparatus 1 separately from the input video signal. Furthermore, these display contents parameter or output level parameter may be generated by an author of the input image, or may be generated by a user of the display apparatus 1. Additionally, it may be externally inputted by the user using an external input device such as a remote controller, a key board, a mouse, a touch panel or an operation button, and so on.

In this case, the output level control portion 21 is preferably designed to obtain these display contents parameter or output level parameter. Thereby, the output level control portion 21 can designate a predetermined distribution curve, depending on these display contents parameter or output level parameter.

However, a stereoscopic image having a sufficient level of the three-dimensional effect can be displayed, by designating the distribution curve by default, even in the case that these display contents parameter and output level parameter are not included. Alternatively, the observer himself/herself may designate the distribution curve, if the observer is provided with an external input device to designate directly the distribution curve.

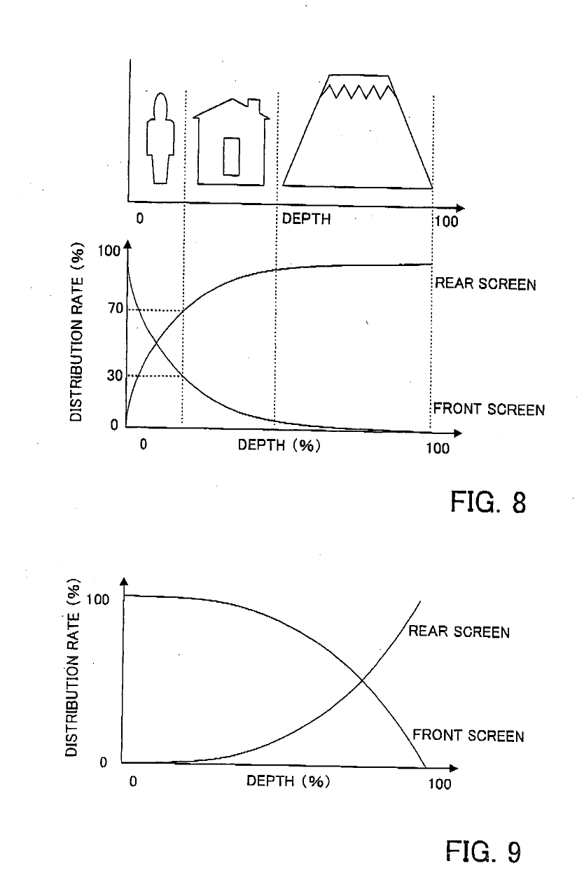

Next, with reference to FIG. 8 to FIG. 15, another example of the distribution curve designated by the output level control portion 21 is explained. The drawings from FIG. 8 to FIG. 15 are graphs illustrating various relationships between the depth in percent and the distribution rate in percent.

For example, as shown in FIG. 8, it is possible to designate a distribution curve to emphasize the three-dimensional effect of the “man part of the image”. In this case, a 0-70% range of the “change in the distribution rate” (or 100-30% range) is assigned to the “man part of the image” existing at any depth position within a 0-20% range of the depth. Therefore, as a stereoscopic image to be displayed on the display apparatus 1, the “man part of the image” is displayed at any depth position within a 0-70% range of the depth. On the other hand, since the distribution rate does not change almost at all or change to a very little extent in the “mountain part of the image”, the mountain is displayed like as the background, as the stereoscopic image to be displayed on the display apparatus 1.

Alternatively, as shown in FIG. 9 for example, distribution curves, on the basis of which the three-dimensional effect of the “mountain part of the image” is emphasized, may be designated. In this case, the “man part of the image” is displayed on the front screen 11, as if it was displayed in two-dimension.

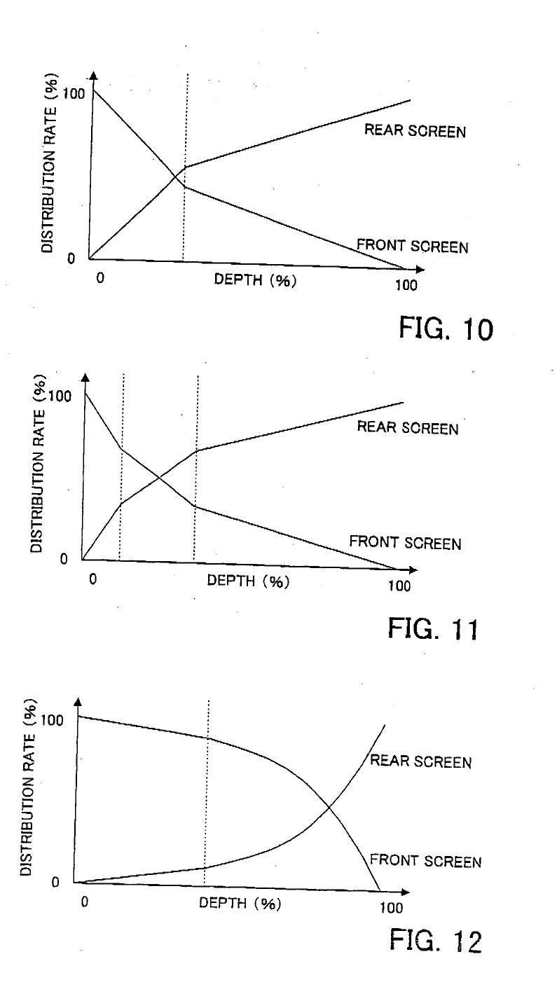

Alternatively, as shown in FIG. 10 for example, distribution curves may be designated, each of which does not have a constant change rate and is obtained by combining optionally two lines having different change rates from each other. That is, in FIG. 10, distribution curves may be designated, each of which has different change rates (i.e. slopes) on either sides of a boundary that is defined at a depth in percent indicated by a dotted line. In this case, it is possible to emphasize the three-dimensional effect within a low range of the depth in percent (i.e. a nearer part as seen from the observer) and weaken the three-dimensional effect within a high range of the depth in percent (i.e. a farther part as seen from the observer).

Alternatively, as shown in FIG. 11, distribution curves may be designated, each of which is obtained by combining three (or more) lines having different change rates from each other. That is, in FIG. 11, distribution curves may be designated, each of which has different change rates i.e. slopes) on either sides of two boundaries respectively, two boundaries being defined respectively at each depth in percent indicated by each of two dotted lines.

Thus, changing the change rate of the distribution curve to the depth, for each predetermined depth, enables to provide a desired three-dimensional effect for each object to be displayed, without distorting or contorting the three-dimensional effect of the object to be displayed whose three-dimensional effect is obtained at the depth in percent.

Alternatively, as shown in FIG. 12, distribution curves may be designated, each of which comprises a line in part (i.e. liner relationship to the depth) and a curve (i.e. non-linear relationship to the depth) in part along the depth. That is, in the graph of FIG. 12, distribution curves may be designated, each of which appears as a predetermined line within a nearer part than an inflection point and appears as a predetermined curve within a farther part than the inflection point, the infection point being defined at a depth in percent indicated by a dotted line.

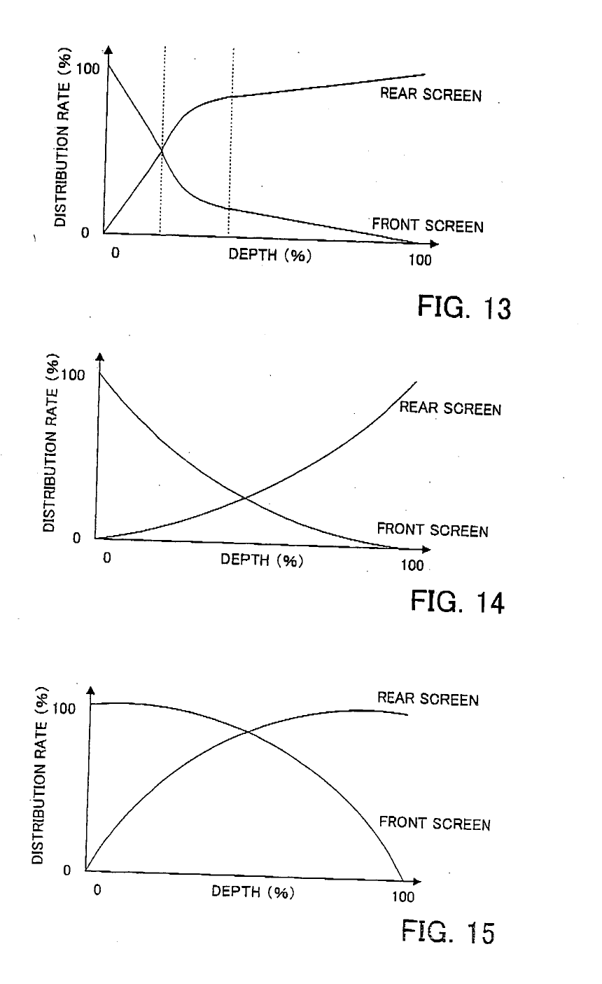

Alternatively, as shown in FIG. 13, distribution curves may be designated, each of which is obtained by combing line parts and curve parts. Also in this case, in the graph of FIG. 13, distribution curves having inflection points respectively defined at depths in percent respectively indicated by two dotted lines may be designated.

Thus, such distribution curves respectively comprising the linear part(s) of the distribution curve and the non-linear part(s) of the distribution curve enables to provide more appropriate three-dimensional effect for each object to be displayed for example.

Alternatively, as shown in FIG. 14, distribution curves may be designated, in which the sum of a distribution rate of the front screen 11 and a distribution rate of the rear screen 12 is less than 100%, instead of the sum equal to 100%. Alternatively, as shown in FIG. 15, distribution curves may be designated, in which the sum of a distribution rate of the front screen 11 and a distribution rate of the rear screen 12 more than 100%, instead of the sum equal to 100%. Incidentally, these distribution curves are preferably designated, in the case that gamma characteristics of the front screen 11 and the rear screen 12 are taken into account. However, it is possible to obtain a satisfactory extent of the three-dimensional effect, by designating such la distribution curves, even in a case other than the case that the gamma characteristics are taken into account.

Alternatively, not limited to such distribution curves, any distribution curve may be designated, insofar as a relationship between the depth and the distribution rate is defined (e.g. including a curve indicated by a predetermined function or table) on the basis of the distribution curve.

As discussed above, according to the first embodiment of the display apparatus of the invention, it is possible to display a stereoscopic image with a predetermined or desired three-dimensional effect, depending on the contents of the input image (image to be displayed). Therefore, the observer can view a stereoscopic image with the optimal or appropriate three-dimensional effect, no matter what the image contents to be displayed are.

### Second Embodiment

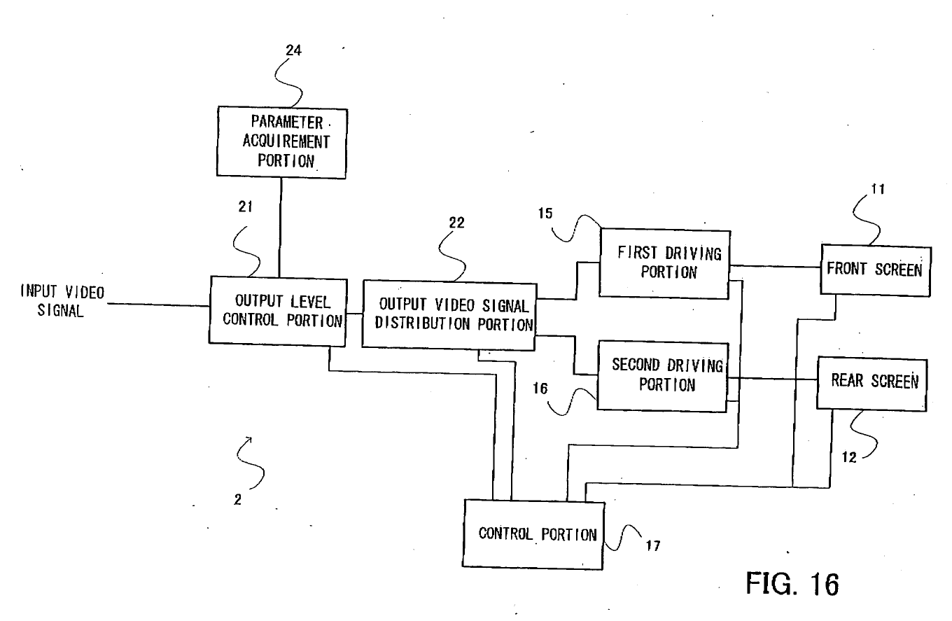

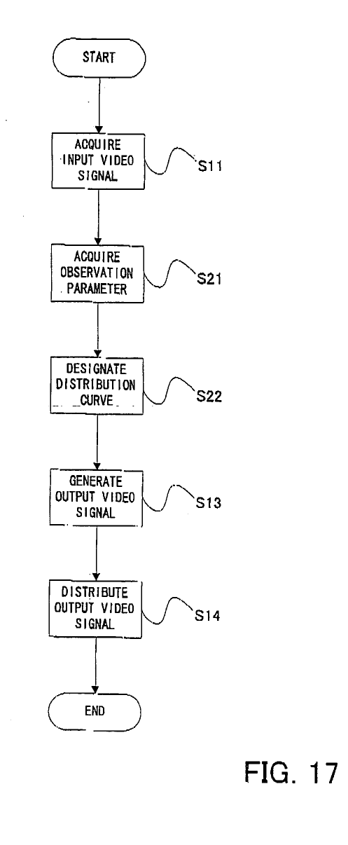

Next, with reference to FIG. 16 and FIG. 17, the second embodiment of the display apparatus according to the present invention will be discussed. Incidentally, in the second embodiment of the display apparatus, parts of the construction the same as the first embodiment carry the same numerals (reference number and step number) and the explanation of them is omitted.

### Fundamental Construction of Second Embodiment

Firstly, with reference to FIG. 16, the fundamental construction of the second embodiment of the display apparatus according to the present invention is explained. FIG. 16 is a block diagram illustrating a fundamental construction of the second embodiment of the display apparatus according to the present invention.

As shown in FIG. 16, the display apparatus 2 is provided with: a front screen 11; a rear screen 12; a first driving portion 15; a second driving portion 16; a control portion 17; an output level control portion 21; an output video signal distribution portion 22; and a parameter acquirement portion 24.

Particularly in the second embodiment, the parameter acquirement portion 24 can acquire an observation parameter indicating an observation condition of a virtual observer who observes or views object, which is indicated by images displayed on the front screen 11 and the rear screen 12. Then, it outputs the acquired observation parameter to the output level control portion 21, which in turn designates a predetermined distribution curve on the basis of the observation parameter.

Incidentally, the observation parameter may be acquired from a monitor device for monitoring an observation condition of a real observer. Alternatively, a parameter designated by the observer (i.e. a parameter indicating the observation condition of the virtual observer) may be acquired as the observation parameter, if an external input portion, such as a remote controller, a touch panel, a mouse, a keyboard or an operational button, is provided.

### Exemplary Operation of Second Embodiment

Next, with reference to FIG. 17, an exemplary operation of the second embodiment of the display apparatus according to the present invention is explained. FIG. 17 is a flow chart illustrating an operational flow of the second embodiment of the display apparatus according to the present invention.

As shown in FIG. 17, the output level control portion 21 acquires an input video signal (step S11). Then, the parameter acquirement portion 24 acquires the observation parameter (step S21).

This observation parameter preferably includes information for specifying an observation position (or a view point), a view line, a view range (or a viewing angle) of the virtual observer, or specifying a distance between the virtual observer and an object displayed by the display apparatus 2. That is, for example, it may include information indicating “the virtual observer views the displayed object from the front thereof with a distance of 2 meters therefrom”.

Then, the output level control portion 21 designates a distribution curve (step S22). A desired distribution curve may be designated as the distribution curve, similarly to the first embodiment. Particularly in the second embodiment, the output level control portion 21 preferably designates a distribution curve, on the basis of the observation parameter acquired by the parameter acquirement portion 24 at the step S21.

That is, it is preferable to designate a distribution curve capable of providing the optimal or appropriate three-dimensional effect to the observer, depending on the observation position, the view range (or the viewing angle) or the view line of the virtual observer, otherwise depending on the distance between the virtual observer and the object displayed or to be displayed. For example, if the view range of the virtual observer has a wide angle like as fish-eye lens, it is preferable to designate a distribution curve (or an output brightness level) to emphasize the three-dimensional effect of a display object existing at a central position within the view range for example.

Alternatively, an appropriate distribution curve may be designated, depending on an observation parameter set by the observer himself/herself. That is, an appropriate distribution curve may be designated, in accordance with an observation condition desired by the observer. In this case, if the observer views the object from a position relatively far from the display apparatus 2, a size of the “man part of the image” in a depth direction becomes smaller in comparison with the distance between the observer and the display apparatus 2. Thereby, the three-dimensional effect of the “man part of the image” provided to the observer becomes weak. Therefore, the output level control portion 21 preferably designates an appropriate distribution curve to broaden a changing range of the brightness of the “man part of the image”, depending on the observation parameter inputted by the observer taking his/her observation condition into account. Thereby, the observer can get all appropriate three-dimensional effect with regard to the “man part of the image”, even if the observer becomes away from the display apparatus 2.

Then, the output video signal distribution portion 22 generates an output video signal for the front screen 11 and an output video signal for the rear screen 12, on the basis of the distribution curve designated at the step S22 (step S13). Then, the output video signal distribution portion 22 outputs the output video signal for the front screen 11 to the first driving portion 15 and the output video signal for the rear screen 12 to the second driving portion 16, respectively (step S15).

Thereby, images with the appropriately controlled brightness are displayed on the front screen 11 and the rear screen 12 respectively, so that the observer can view a stereoscopic image.

As discussed above, according to the second embodiment of the display apparatus of the invention, it is possible to display a stereoscopic image with a predetermined or desired three-dimensional effect, depending on an observation condition of a virtual observer, for example taking observer's perspective or the like into account. Therefore, the observer can view a stereoscopic image with the optimal or appropriate three-dimensional effect, no matter what the image contents to be displayed are.

Incidentally, also in the second embodiment, a further appropriate distribution curve may be designated, further taking an image contents i.e. display contents parameter) into account, similarly to the first embodiment.

Incidentally, in the first and second embodiments discussed above, a stereoscopic image is displayed by means of two displaying devices disposed frontward and rearward. Nevertheless, further numbers of displaying devices may be disposed in tandem, so that a further natural and smoothed stereoscopic image is obtained.

Furthermore, for example, brightness, color tone or focusing and so on of a display object existing within a selected depth range may be changed to display a stereoscopic image, in addition to designating a specific distribution rate or output brightness level as discussed above.

Additionally, it is possible to obtain a satisfactory advantage or effect of the present invention, not only in the brightness modulation type of stereoscopic display system, but also in any stereoscopic display system or three-dimensional display system.

The invention may be embodied in other specific forms without departing from the spirit or essential characteristics thereof The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-156497 filed on Jun. 2, 2003 including the specification, claims, drawings and summary is incorporated herein by reference in its entirety.

What is claimed is:

1. A display apparatus comprising:
a plurality of displaying devices disposed in tandem on a view line of an observer, for displaying a plurality of images relating to a plurality of display objects in an overlapped manner on the view line;
an output level control device for designating an output brightness level of each of the plurality of images, depending on both (i) a depth position of each of the plurality of display objects, the depth position being defined between or among the plurality of displaying devices and (ii) contents of each of the plurality of display objects; and
an output level distribution device for distributing an input video signal for displaying the plurality of display objects, as an output video signal having the designated output brightness level, to each of the plurality of displaying devices.

2. The display apparatus according to claim 1, wherein
said output level control device designates the output brightness level, so that a wide range of the output brightness level is assigned to an output video signal relating to a display object, among the plurality of display objects, to be emphasized in its three-dimensional effect.

3. The display apparatus according to claim 1, wherein
said output level control device designates the output brightness level, so that a narrow range of the output brightness level is assigned to an output video signal relating to a display object, among the plurality of display objects, to be weakened in its three-dimensional effect.

4. The display apparatus according to claim 1, further comprising a parameter acquirement device for acquiring a display contents parameter indicating at least one content of the plurality of display objects, wherein
said output level control device designates the output brightness level, on the basis of the display contents parameter acquired by said parameter acquirement device.

5. A display apparatus comprising:
a plurality of displaying devices disposed in tandem on a view line of an observer, for displaying a plurality of images relating to a plurality of display objects in an overlapped manner on the view line;
a parameter acquirement device for acquiring a condition parameter indicating an observation condition under which a virtual observer observes the plurality of display objects, the virtual observer being assumed existing within a space in which the plurality of display objects are disposed;
an output level control device for designating an output brightness level of each of the plurality of images, depending on both (i) a depth position of each of the plurality of display objects, the depth position being defined between or among the plurality of displaying devices and (ii) contents of each of the plurality of display objects; and
an output level distribution device for distributing an input video signal for displaying the plurality of display objects, as an output video signal having the designated output brightness level, to each of the plurality or displaying devices.

6. The display apparatus according to claim 5, wherein
said condition parameter includes at least one of (i) information relating to an observation position of the virtual observer, (ii) information relating to a distance between the virtual observer and at least one of the plurality of display objects, and (iii) information relating to a visual range of the virtual observer.

7. The display apparatus according to claim 5, wherein
said output level control device designates the output brightness level, so that a wide range of the output brightness level is assigned to an output video signal relating to a display object, among the plurality of display objects, to be emphasized in its three-dimensional effect, and so that a narrow range of the output brightness level is assigned to an output video signal relating to a display object, among the plurality of display objects, to be weakened in its three-dimensional effect.

8. The display apparatus according to claim 1, wherein
said output level control device designates the output brightness level, so that the output brightness level changes in a non-linear manner relative to the depth position.

9. The display apparatus according to claim 1, wherein
said output level control device designates the output brightness level so that the output brightness level relating to the plurality of images about one display object changes in a linear manner relative to the depth position within a range portion in which said one display object exists, the range portion being a part of a depth range that is a range in a depth direction along the view line and in which the plurality of display objects exist.

10. The display apparatus according to claim 1, wherein
said output level control device designates the output brightness level, so that the output brightness level relating to the plurality of images about at least one display object changes in a linear manner relative to the depth position within a range portion in which the plurality of display objects including said at least one display object exist, the range portion being a part of a depth range that is a range in a depth direction along the view line and in which the plurality of display objects exist, and so that the output brightness level relating to the plurality of images about at least another one display object changes in a non-linear manner relative to the depth position, within another range portion in which the plurality of display objects including said at least another one display object exist, said another range portion being a part of the depth range.

11. The display apparatus according to claim 1, wherein
said output level control device designates the output brightness level, so that the output brightness level with regard to a part of the plurality of display objects to be displayed frontward as seen from the observer decreases monotonously in proportion to an increase of a value indicating the depth position, and so that the output brightness level with regard to a part of the plurality of display objects to be displayed rearward as seen from the observer increases monotonously in proportion to an increase of the value indicating the depth position.

12. The display apparatus according to claim 1, wherein
the input video signal is added with depth information indicating the depth position with regard to at least one display object of the plurality of display objects.

13. The display apparatus according to claim 1, wherein
each of the plurality of displaying devices can be controlled for each pixel,
said output level control device designates the output brightness level for said each pixel, and
said output level distribution device distributes the output video signal for said each pixel.

14. A display apparatus comprising:
a dividing device for dividing a depth range that is a range in a depth direction of a stereoscopic display image including a plurality of display objects into a plurality of range portions each having a desired range;
a parameter providing device for providing a three-dimensional effect parameter to each of the plurality of range portions, the three-dimensional effect parameter indicating an extent of three-dimensional effect in the depth direction to be applied on at least one of the plurality of display objects existing in one of the plurality of range portions, depending on both (i) contents of said at least one of the plurality of display objects and (ii) a depth position of said at least one of the plurality of display objects; and
a displaying device for displaying stereoscopically said at least one of the plurality of display objects, so that the extent of three-dimensional effect indicated by the three-dimensional effect parameter is applied thereon.

15. The display apparatus according to claim 14, wherein
said displaying device displays entirely the stereoscopic display image, by displaying a plurality of images each relating to the plurality of display objects and disposed in tandem on a view line of an observer along the depth direction, the plurality of images being displayed in an overlapped manner on the view line,
said parameter providing device provides the three-dimensional effect parameter to at least one of the plurality of display objects, by (i) designating an output brightness level for each of the plurality of images on the basis of the depth position and the contents, and (ii) distributing output video signals having the designated output brightness level as for said at least one of the plurality of display objects into each of the plurality of displaying devices.

16. The display apparatus according to claim 1, wherein
the plurality of display devices other than at least one thereof disposed at the rearmost position as seen from the observer is/are semi-transparent.

17. A display method implemented with a display apparatus provided with a plurality of displaying devices disposed in tandem on a view line of an observer, for displaying a plurality of images relating to a plurality of display objects in an overlapped manner on the view line, said display method comprising:
an output level control process of designating an output brightness level of each of the plurality of images, depending on both (i) a depth position of each of the plurality of display objects, the depth position being defined between or among the plurality of displaying devices and (ii) contents of each of the plurality of display objects; and
an output level distribution process of distributing an input video signal for displaying the plurality of display objects, as an output video signal having the designated output brightness level, to each of the plurality of displaying devices.

18. A display method implemented with a display apparatus provided with a plurality of displaying devices disposed in tandem on a view line of an observer, for displaying a plurality of images relating to a plurality of display objects in an overlapped manner on the view line, said display method comprising:
a parameter acquirement process of acquiring a condition parameter indicating an observation condition under which a virtual observer observes the plurality of display objects, the virtual observer being assumed existing within a space in which the plurality of display objects are disposed;
an output level control process of designating an output brightness level of each of the plurality of images, depending on both (i) a depth position of each of the plurality of display objects, the depth position being defined between or among the plurality of displaying devices and (ii) contents of each of the plurality of display objects; and
an output level distribution process of distributing an input video signal for displaying the plurality of display objects, as an output video signal having the designated output brightness level, to each of the plurality of displaying devices.

19. A display method comprising:
a dividing process of dividing a depth range that is a range in a depth direction of a stereoscopic display image including a plurality of display objects into a plurality of range portions each having a desired range;
a parameter providing process of providing a three-dimensional effect parameter to each of the plurality of range portions, the three-dimensional effect parameter indicating an extent of three-dimensional effect in the depth direction to be applied on at least one of the plurality of display objects existing in one of the plurality of range portions, depending on both (i) contents of said at least one of the plurality of display objects and (ii) a depth position of said at least one of the plurality of display objects; and
a displaying process of displaying stereoscopically said at least one of the plurality of display objects, so that the extent of three-dimensional effect indicated by the three-dimensional effect parameter is applied thereon.

20. The display apparatus according to claim 5, wherein
each of the plurality of displaying devices can be controlled for each pixel,
said output level control device designates the output brightness level for said each pixel, and
said output level distribution device distributes the output video signal for said each pixel.

21. The display apparatus according to claim 5, wherein
the input video signal is added with depth information indicating the depth position with regard to at least one display object of the plurality of display objects.

22. The display apparatus according to claim 5, wherein
said output level control device designates the output brightness level, so that the output brightness level with regard to a part of the plurality of display objects to be displayed frontward as seen from the observer decreases monotonously in proportion to an increase of a value indicating the depth position, and so that the output brightness level with regard to a part of the plurality of display objects to be displayed rearward as seen from the observer increases monotonously in proportion to an increase of the value indicating the depth position.

23. The display apparatus according to claim 5, wherein
said output level control device designates the output brightness level, so that the output brightness level defined for the plurality of images relating to at least one display object changes in a linear manner relative to the depth position, within a range portion in which the plurality of display objects including said at least one display object exist, the range portion being a part of a depth range that is a range in a depth direction along the view line and in which the plurality of display objects exist, and so that the output brightness level defined for the plurality of images relating to at least another one display object changes in a non-linear manner relative to the depth position, within another range portion in which the plurality of display objects including said at least another one display object exist, said another range portion being a part of the depth range.

24. The display apparatus according to claim 5, wherein
said output level control device designates the output brightness level, so that the output brightness level defined for the plurality of images relating to one display object changes in a linear manner relative to the depth position, within a range portion in which said one display object exists, the range portion being a part of a depth range that is a range in a depth direction along the view line and in which the plurality of display objects exist.

25. The display apparatus according to claim 5, wherein
said output level control device designates the output brightness level, so that the output brightness level changes in a non-linear manner relative to the depth position.

26. The display apparatus according to claim 5, wherein
the plurality of display devices other than at least one thereof disposed at the rearmost position as seen from the observer is/are semi-transparent.

27. The display apparatus according to claim 14, wherein
the plurality of display devices other than at least one thereof disposed at the rearmost position as seen from the observer is/are semi-transparent.
